(19) United States
(12) Patent Application Publication
(10) Pub. No.: US 2017/0284709 A1
(43) Pub. Date: Oct. 5, 2017

(54) TEMPERATURE CONTROL DEVICE

(71) Applicant: Mahle International GmbH, Stuttgart (DE)

(72) Inventors: Stefan Hirsch, Stuttgart (DE); Juergen Gruenwald, Ludwigsburg (DE); Joachim Treier, Oppenau (DE)

(73) Assignee: Mahle International GmbH, Stuttgart (DE)

(21) Appl. No.: 15/507,730

(22) PCT Filed: Jul. 30, 2015
(86) PCT No.: PCT/EP2015/067581

§ 371 Date: Feb. 28, 2017

(30) Foreign Application Priority Data
Aug. 29, 2014 (DE) 10 2014 217 336.1

(51) Int. Cl. F25B 21/04; H01M 10/6572; H01M 10/6556; H01M 10/48; H01M 10/617

(52) U.S. Cl. CPC F25B 21/04; H01M 10/486; H01M 10/617; H01M 10/6556; H01M 10/6572; F25B 2321/021; F25B 2321/023; F25B 2321/0252; H01M 2/1077

(57) ABSTRACT

A temperature control device may include a temperature control structure through which a fluid may be flowable and may have at least one first pipe wall defining an interior, and at least one thermoelectric module, which on a side facing away from the interior chamber of the temperature control structure may be arranged on the first pipe wall. The thermoelectric module may include at least two rows of elements each extending along an extension direction and with at least two thermoelectric elements. The thermoelectric elements of each of the at least two rows of elements may be electrically connected in series to forming a first and a second electric branch conductor. In at least one row of elements, an electric switch switchable between closed and opened states may be provided.

### CROSS REFERENCE TO RELATED APPLICATIONS

This application claims priority to DE-10 2014 217 336.1, filed Aug. 29, 2014 and PCT/EP2015/067581, filed Jul. 30, 2015. The contents of both of these applications are hereby incorporated by reference in their entirety.

### TECHNICAL FIELD

The invention relates to a temperature control device and to a battery arrangement having such a temperature control device.

### BACKGROUND

In modern hybrid and electric motor vehicles, lithium ion batteries are often employed as rechargeable energy storage units. A battery optimized with respect to lifespan and maximum energy storage quantity requires a correspondingly efficient temperature control device for the individual battery cells, which is capable in particular of preventing the battery heating up beyond a maximum operating temperature.

Before this background, active temperature control devices are known from the prior art which comprise a temperature control structure through which a temperature control medium in the form of a fluid can flow. Such a temperature control structure typically comprises two temperature control plates delimiting a fluid duct. Said temperature control structure acts as a heat source or heat sink and allows the heat exchange between the battery to be temperature controlled and the fluid. The heat exchange can be supported by thermoelectric elements in the form of so-called Peltier elements, which are attached in defined places between the battery to be temperature controlled and the temperature control plates.

From the prior art, DE 10 2012 211 259 A1 is known for example, which describes such a temperature control device.

With such temperature control devices it proves problematic to achieve as homogenous as possible a cooling of the battery cells in the individual battery cells of a battery coupled to the temperature control device.

### SUMMARY

It is therefore an object of the present invention to create an improved embodiment of a temperature control device which makes possible a homogeneous temperature control of the battery cells of a battery which is thermally coupled to the temperature control device. Furthermore it is an object of the present invention to create a battery arrangement with such a temperature control device.

These objects are solved through the subject of the independent patent claims. Preferred embodiments are subject of the dependent patent claims.

Accordingly, the basic idea of the invention is to equip a temperature control device with at least two rows of elements of thermoelectric elements, wherein at least one row of elements can be electrically switched on or switched off optionally with the help of an electric switching element. In this way, the thermoelectric elements of each row of elements can be individually activated or deactivated for the temperature control of the battery cell that is thermally coupled to the thermoelectric elements.

This makes it possible, in particular, to react to so-called hotspots in the battery cell to be temperature controlled. These are local housing zones of the battery cell with locally elevated or lowered temperature which in turn require a locally elevated or reduced temperature control performance in order to achieve an altogether homogenous temperature control of the battery cell.

However, the concept of at least one row of elements of thermoelectric elements that can be optionally switched on or switched off develops its advantageous effect to a particular degree in particular when a controllable electric switching element is present not only in one row of element but in preferably many of the existing rows of elements, particularly preferably in all existing rows of elements. With increasing number of such electric switching elements, the achievable flexibility with respect to regions of the battery cell to be individually temperature controlled can be sustainably improved.

A temperature control device for the temperature control of at least one battery cell of a battery according to the invention comprises a temperature control structure through which a fluid can flow, the interior chamber of which is delimited by at least one pipe wall. Typically, such a temperature control structure can be designed tubular, for example in the manner of a flat pipe, so that the pipe walls of the same delimit the interior chamber of the temperature control structure. Furthermore, the temperature control device according to the invention comprises at least one thermoelectric module which on a side facing away from the interior chamber of the temperature control structure is arranged on the pipe wall of the temperature control structure. The thermoelectric module comprises a first and at least one second row of elements each with at least two thermoelectric elements, wherein the at least two rows of element in each case extend along an extension direction. These rows of elements formed of at least two thermoelectric elements assume the function of conventional Peltier elements.

According to the invention, an electric switching element is now provided in at least one row of elements, which can be switched over between a closed and an opened state. In the close state, electric current can flow through the thermoelectric elements of the row of elements assigned to the switching element, in the opened state this is not possible.

A geometrically particularly compact construction of the temperature control device can be achieved in a preferred embodiment according to which the thermoelectric elements of a row of elements are arranged substantially linearly along a longitudinal direction and the at least two rows of elements are arranged adjacent to one another along a transverse direction running transversely to the longitudinal direction. In this scenario, the extension direction of the thermoelectric elements and the longitudinal direction are identical. Here, the thermoelectric elements of the thermoelectric module are arranged along a vertical direction which runs orthogonally both with respect to the longitudinal direction and also with respect to the transverse direction, between a first electrically insulating insulation element and a second electrically insulating insulation element. The second electrically insulating insulation element is arranged in vertical direction between the thermoelectric elements and the pipe wall of the temperature control structure. Such an arrangement geometry makes possible an improved thermal contact with the battery cell to be temperature controlled, in particular when the same comprises a substantially flat housing wall. This can then be mechanically brought into contact with the pipe wall of the temperature control structure along the longitudinal direction of the rows of elements so that an optimal thermal contact materialises.

In a particularly preferred embodiment, the thermoelectric module can comprise at least one temperature sensor for measuring the temperature of the battery cell that is thermally coupled to the thermoelectric module.

This makes possible in particular taking into account the temperature measured by the temperature sensor when activating the at least one electric switching element. In this way, a closed-loop control of the temperature of the battery cell can be realised.

To this end, the temperature control device in an advantageous further development of the invention can comprise an open-loop/closed-loop control unit interacting with the at least one electric switching element and with the at least one temperature sensor. The open-loop/closed-loop control unit is equipped/programmed in such a manner that it switches the electric switching element over between the opened and the closed state as a function of the temperature measured by the temperature sensor. In conjunction with the open-loop/closed-loop control unit, temperature sensor thus permits a closed-loop control of the heating or cooling performance provided by the thermoelectric elements of the rows of elements as a function of the temperature of the battery cell coupled to these thermoelectric elements. This results in an improved, in particular particularly homogenous temperature control of the battery cell through targeted switching-on and switching-off of individual rows of elements with the help of the electric switching elements.

According to a particularly preferred embodiment, at least temperature sensor, preferentially at least two temperature sensors, particularly preferably a plurality of temperature sensors can be provided in at least two rows of elements, particularly preferably in all rows of elements for measuring the temperature of a battery cell that is thermally coupled to the respective row of elements of the thermoelectric module. According to this, the open-loop/closed-loop control unit is also designed in such a manner that the electric switching element assigned to a certain row of elements is activated by the open-loop/closed-loop control unit as a function of the temperature, which can be determined with the at least one temperature sensor assigned to the same row elements. In this way, an individual closed-loop control using the already explained open-loop/closed-loop control unit of the individual branch conductors or rows of elements with the associated thermoelectric elements is realised. This opens up the possibility of individually activating local zones of the temperature control structure with respect to the heating or cooling structure provided by the thermoelectric elements in these zones. Because of this it is possible to react particularly favourably to the potential formation of the already mentioned hotspots.

In a particularly preferred embodiment, the at least one electric switching element can comprise a semiconductor switch, in particular a thyristor. By means of such a semiconductor switch the controllability of the electric switching element required for realising the closed-loop temperature control explained above can be explained in a particularly simple manner. The use of a thyristor is recommended since the same is suitable to a particular degree for controlling high electric currents such as are required for operating thermoelectric elements.

In another preferred embodiment, the temperature sensor can be designed as an infrared sensor by means of which for determining the temperature the infrared radiation emitted by the battery cell is measurable. This allows a particularly accurate determination of the temperature.

In a further preferred embodiment, the at least one electric switching element can be provided on a side of the thermoelectric module facing the temperature control structure. In this way it can be avoided that waste heat by the electric switching element during operation influences the temperature control of the battery cell in an interfering manner.

In an advantageous further development, the temperature control structure can be equipped with a fluid duct structure adapted to the rows of elements or to the branch conductors. It is conceivable that in the temperature control structure a fluid duct is provided for each row of elements namely in such a manner that each fluid duct is thermally coupled to the row of elements to which it is assigned. Here, the at least one pipe wall of the temperature control structure separates the respective fluid duct from the row of elements to which it is assigned. It is proposed, furthermore, to provide a valve element in at least one fluid duct, preferentially in all fluid ducts, which is adjustable between a closed position, in which it closes off the fluid duct, and an opened position, in which it opens the fluid duct for fluid to flow through. This allows flexibly varying the temperature control effect brought about by means of the fluid duct concerned. If the fluid flowing through the fluid duct is for example a coolant, the cooling effect generated by the fluid can be drastically reduced locally in the region of this fluid duct by closing the fluid duct. By adjusting the valve element into its opened position, the cooling performance provided by the fluid is maximised by contrast. This makes it possible in particular reacting to the already explained hotspots in the battery cell to be cooled.

The concept of a “switchable” fluid duct with adjustable fluid flow rate introduced here therefore develops its advantageous effect to a particular degree in particular when preferably many, particularly preferably all fluid ducts are equipped with an adjustable valve element.

In a preferred embodiment, an electric actuator element interacting with the valve element can be provided in that row of elements which is assigned a fluid duct comprising a valve element, which is electrically connected to the at least two thermoelectric elements of this row of elements. The electric actuator element in this case has two operating states and interacts with the valve element of the corresponding fluid duct in such a manner that it adjusts the valve element in a first operating state into the opened position and in a second operating state adjusts the same into the closed position or vice versa. Such a configuration allows coupling the thermoelectric elements of a certain row of elements to the valve element of the fluid duct assigned to this row of elements. Accordingly, the heating or cooling performance generated by the thermoelectric elements can also be advantageously coupled to the heating or cooling performance generated by the fluid flowing through the fluid duct. The closed-loop temperature control explained above by switching individual rows of elements of thermoelectric elements on and off can also be transferred to the fluid ducts through which a fluid can flow in this way. Switching over an electric switching element into the opened position then does not result in that the thermoelectric elements of the thermoelectric elements concerned no longer contribute to the temperature control of the battery cell but that by switching over of the associated valve element into the closed position associated with the opening of the switching element into the closed position the corresponding fluid duct is also closed at the same time. Accordingly, the fluid duct can also no longer contribute to the temperature control of the battery cell. Conversely, switching over the electric switching element into the closed position causes electric current to flow through the thermoelectric elements so that these contribute to the temperature control of the battery cell. At the same time, switching over the electric switching element into the closed position can also cause an adjusting of the valve element into the opened position so that a fluid can flow through the fluid duct and contribute to the temperature control of the battery cell.

In an advantageous further development, the electric actuator element can comprise a coil element electrically connected in series with the at least two thermoelectric elements, which in the first operating state is flowed through by electric current, but not in the second operating state. In the first operating state, a magnetic field can thus be generated by the electric current flowing through the electric coil element, which magnetic field through magnetic interaction with the valve element causes the adjustment of the latter between the opened and the closed position.

Particularly practically, the electric actuator element can be designed in such a manner that it interacts free of contact with the valve element for adjusting between the opened and the closed position. This may preferentially take place via the already mentioned magnetic coupling when the valve element is provided with a magnetic component, for example a magnetised component, which interacts with the magnetic field generated by the electric coil element.

In a preferred embodiment, the valve element can comprise a spring-elastic element, in particular a leaf spring, which is preloaded against the opened or against the closed position. Such a spring-elastic element is easy to produce in terms of production and requires only little installation space so that it can be space-savingly installed in the temperature structure. In addition it can also be produced cost-effectively which results in reduced production costs of the entire temperature control device, in particular when a plurality of such spring-elastic elements is to be installed. The preloading of the spring-elastic elements against the opened or closed position proposed here additionally allows realising an activation principle with which the person skilled in the art is familiar as failsafe function. Alternatively to this, a design as microvalve is also conceivable.

In a further preferred embodiment, the actuator element is electrically arranged between two thermoelectric elements. In this way, the required installation space for housing the respective actuator element can be kept small.

Particularly practically, the valve element can be arranged in the region of an actuator element in particular along the extension direction. In this way, the desired coupling between valve element and actuator element can be particularly effectively realised.

Particularly preferably, the electric switching element can also be electrically arranged between two thermoelectric elements. In this way, the electric wiring expenditure for the thermoelectric elements can be kept low.

Particularly practically, the temperature control structure can be designed as a flat pipe, in which the at least two fluid ducts are provided and which with a side facing the thermoelectric module lies flat against the same. This results in an advantageous large-area thermal contact of the fluid ducts of the flat pipe with the thermoelectric module with low installation space requirement at the same time. According to this version, the at least two fluid ducts and the thermoelectric elements of the rows of elements can each extend along the already introduced extension direction. With respect to the likewise already introduced vertical direction, which runs orthogonally both with respect to the extension direction and also with respect to the transverse direction, each fluid duct can thus extend spaced from the row of elements assigned to it and parallel to the same.

The invention, furthermore, relates to a battery arrangement with a thermoelectric device introduced above. The battery arrangement, furthermore, comprises a battery comprising at least one battery cell. The at least one battery cell in this case is arranged on a side of the thermoelectric module facing away from the temperature control structure on said module. In this way, an effective thermal coupling of the at least one battery cell both to the thermoelectric elements and also to the temperature control structure of the temperature control device can be achieved.

In a particularly preferred embodiment, an individual thermoelectric module can be provided for each battery cell to be temperature controlled. By means of such a modular construction of the thermoelectric device the same can be utilised in a flexible manner for the temperature control of basically any number of battery cells. According to this embodiment, the battery arrangement therefore comprises a first and at least one second thermoelectric module. Accordingly, the battery to be temperature controlled comprises a first and an at least a second battery cell. For thermally coupling to the respective thermoelectric module, a housing wall of the housing of a respective battery cell can be mechanically and thus also thermally connected to the pipe wall of the temperature control structure of the corresponding thermoelectric module.

As already mentioned, the modular concept introduced above allows the temperature control of a battery with basically any number of batter cells. In a preferred embodiment of the battery arrangement introduced here, the battery therefore comprises a plurality of battery cells. Here, exactly one thermoelectric module is provided for each battery cell, which is mechanically and thus also thermally connected to this battery cell.

According to a particularly advantageous embodiment of the battery arrangement introduced here, at least one individual temperature sensor can be provided for each pair of a battery cell and thermoelectric module. This makes possible an individual temperature control of the individual battery cells through the thermoelectric module assigned to them and using the joint open-loop/closed-loop control unit introduced above.

In an advantageous further development it is therefore recommended to design the open-loop/closed-loop control unit in such a manner that the same switches the electric switching elements of a respective thermoelectric module between their closed and opened state as a function of the temperature that can be determined by the at least one temperature sensor assigned to this module. This allows switching on and switching off the corresponding rows of elements and fluid ducts as a function of the measured temperature.

In another preferred embodiment, an electrically insulating adapter layer of a heat-conducting material, in particular of an adhesive, can be provided between the at least one battery cell and the temperature control structure, against which lie both the at least one battery cell for heat transfer and also the temperature control structure for the thermal coupling of the at least one battery cell to the temperature control structure. In this way, undesirable intermediate spaces between the housing of the battery cell to be temperature controlled and the thermoelectric module, which are typically accompanied by a reduced thermal coupling, can be avoided.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

It shows, in each case schematically

FIG. 1 an example of a temperature control device for the temperature control according to the invention in a longitudinal section along the section line I-I of FIG. 2,

FIG. 2 the temperature control device of FIG. 1 in a cross section along the section line II-II of FIG. 1,

FIG. 3 the temperature control device of FIG. 1 in a cross section along the section line of FIG. 2,

FIG. 4 a battery arrangement according to the invention with 12 battery cells to be temperature controlled along a section line IV-IV of FIG. 5,

FIG. 5 the battery arrangement of FIG. 4 in a cross section along the section line V-V of FIG. 4,

FIG. 6 a detail representation of FIG. 4 in the region of three neighbouring battery cells or three neighbouring thermoelectric modules.

### DETAILED DESCRIPTION

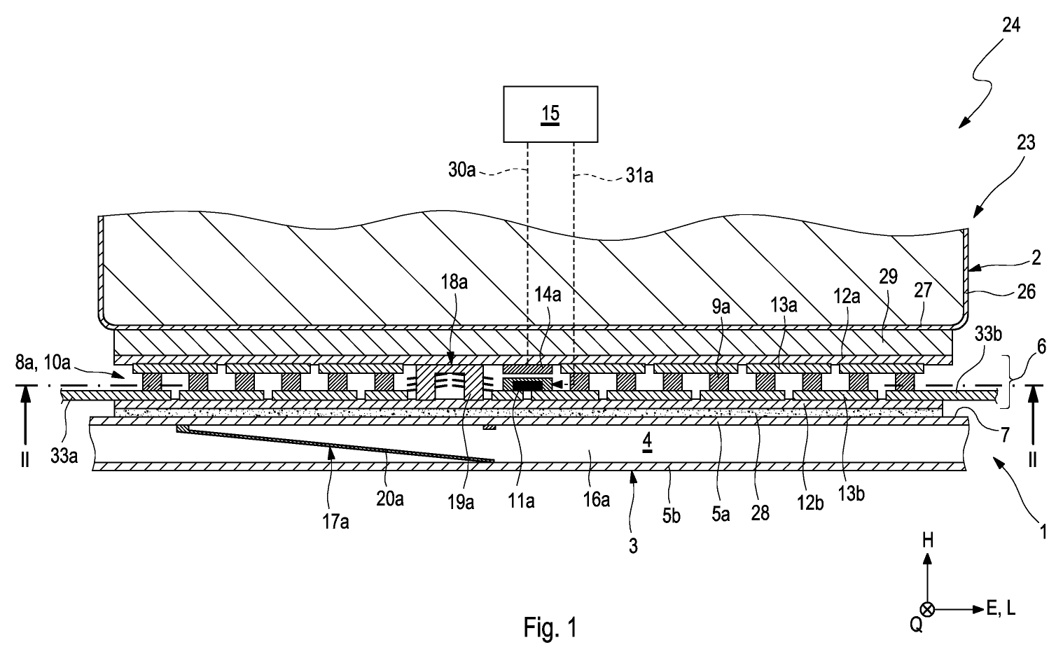

FIG. 1 illustrates an example of a temperature control device 1 according to the invention for the temperature control in a longitudinal section. The temperature control device 1 serves for temperature controlling at least one electrochemical energy supply unit in the form of a battery 23 with at least one battery cell 2. The temperature control device 1 comprises a temperature control structure 3 through which a fluid can flow, the interior chamber 4 of which is delimited by a first and second pipe wall 5a, 5b. The temperature control device 1 furthermore comprises a thermoelectric module 6 which on a side 7 facing away from the interior chamber 4 of the temperature control structure 3 is arranged on the first pipe wall of the pipe 5a of the temperature control structure 3. The thermoelectric module 6 can be fastened to the temperature control structure 3 by means of a contact layer 28 of a thermally conductive adhesive.

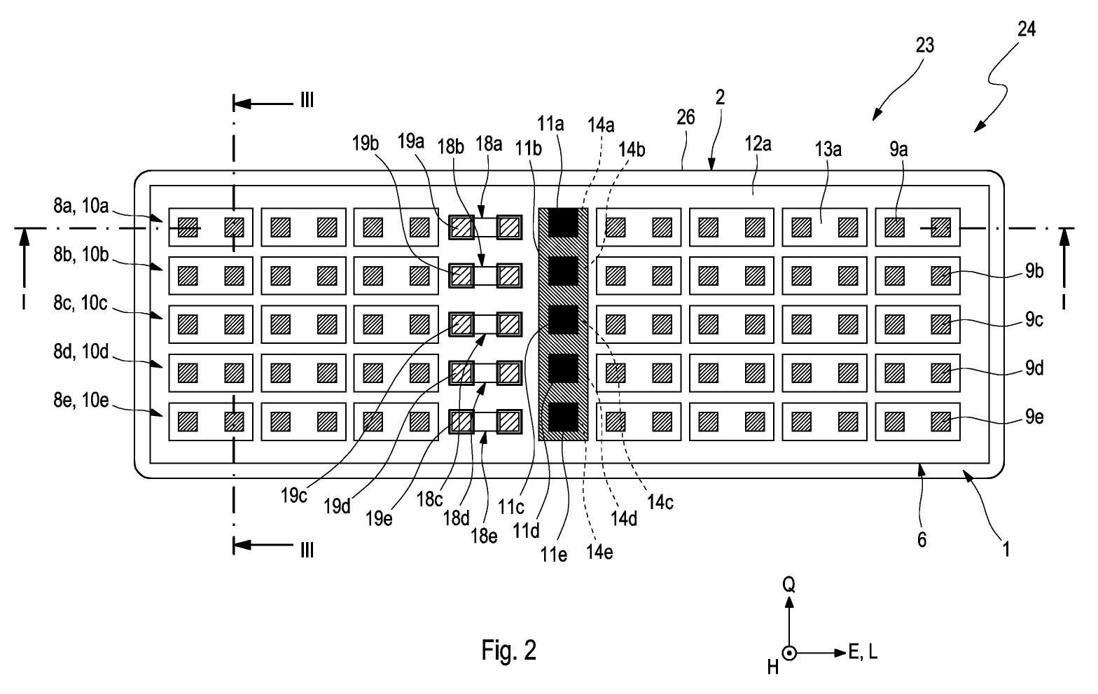

FIG. 2 shows the temperature control device 1 of FIG. 1 in a cross section along the section line II-II of FIG. 1. It can be seen that the thermoelectric module 6—purely exemplarily—comprises five rows of elements 5a-5e each with a plurality of thermoelectric elements 9a-9e. The construction of the thermoelectric elements 9a-9e, which comprise a thermoelectrically active material, is known to the relevant person skilled in the art so that the thermoelectric elements 9a-9e in FIG. 1 are only sketched roughly schematically.

The individual rows of elements 8a-8e each extend along a common extension direction E. The thermoelectric elements 9a-9e of each row of elements 8a-8e are electrically connected in series for forming a respective electric branch conductor 10a-10e. In other words, the thermoelectric elements 9a of the first row of elements 8a form a first electric branch conductor 10a, the thermoelectric elements 9b of the second row of elements 8b form a second electric branch conductor 10b etc. The individual element rows 8a-8e or branch conductors 10a-10e can, as shown in FIG. 1, be connected electrically in parallel by means of electrical connection elements 33a, 33b. By way of the electrical connection elements 33a, 33b, the rows of elements 8a-8e can also be connected to an external source of electric energy (not shown). From FIG. 2 it is evident that the thermoelectric elements 9a-9e of each row of elements 8a-8e are substantially arranged linearly along a longitudinal direction L and adjacent to one another with respect to a transverse direction Q running orthogonally to the longitudinal direction.

Looking again at FIG. 1 it is evident that in the first branch conductor 10a shown in FIG. 1 a first electric switching element 11a is provided, which is electrically connected in series with the thermoelectric elements 9a. Such electric switching elements 11b to 11e can—as shown in FIG. 2—also be provided in the other rows of elements 8b-8e. In simplified versions of the example, only individual rows of elements 8a-8e are equipped with an electric switching element 11a-11e.

Particularly preferably, the respective electric switching element 11a-11e is electrically arranged between two thermoelectric elements 9a-9e. In this way, the required electrical wiring expenditure for the thermoelectric elements 9a-9e can be kept low.

The electric switching elements 11a-11e can each be switched over between a closed and an open state, i.e. the electric switching elements 11a-11e follow the operating principle of an electric switch. In the closed state, the thermoelectric elements 9a-9e of the associated row of elements 8a-8e can be flowed through by an electric current from an external energy source (not shown), in the opened state this is not possible.

FIG. 1 shows that the thermoelectric elements 9a-9e of each row of elements 8a-8e are arranged along a vertical direction H, which runs orthogonally to the longitudinal direction L and to the transverse direction Q, sandwich-like between a first electrically insulating insulating element 12a and a second electrically insulating insulating element 12b. Here, the second insulating element 12b is arranged in vertical direction H between the thermoelectric elements 9a-9e and the first pipe wall 5a of the temperature control structure 3. In the example of the figures, the extension direction E and the longitudinal direction L extend parallel to one another. However, versions are also conceivable in which the extension direction E along a row of elements 8a-8e points in different directions, i.e. varies.

The two insulation elements 12a, 12b can be conventional circuit boards, in which, for example by means of a conventional etching process, conductor tracks in the form or copper bridges 13a, 13b are formed. These are positioned on the sides of the insulation elements 12a, 12b facing the thermoelectric elements 9a-9e in such a manner that they, along the extension direction E, electrically connect adjacent thermoelectric elements 9a-9e of the same branch conductor 10a-10e (see FIG. 1). Such circuit boards can comprise one or more glass fibre-reinforced plastic layer(s). The individual plastic layers of the circuit board can each have layer thicknesses between 50 μm and 300 μm, so that a good heat conductivity of the electrical insulation elements 12a, 12b is ensured, without the electrical insulation required with respect to the battery cell being jeopardised.

In order to achieve a good heat coupling of the battery cell 2 to the thermoelectric module 6, an adapter layer 29 can be provided between the first insulation element 12a and the battery cell 2 to be temperature controlled, which comprises a heat-conducting and/or electrically insulating material. Conceivable is for example using a thermoplastic or a film of a plastic. With suitable dimensioning of the adapter layer 29 it can be prevented that undesirable intermediate spaces can form between the first installation element 12a and the battery cell 2 to be temperature controlled, which diminish the thermal coupling of the battery cell 2 to the electric module 6.

According to FIG. 1, the electric switching elements 11a-11e can be provided on a side of the thermoelectric module 6 facing the temperature control structure 3. In this way, it can be largely or even completely prevented that waste heat generated by the electric switching elements 11a-11e during operation interferes with the temperature control of the battery cell 2.

The thermoelectric module 1 also comprises temperature sensors 14a-14e for measuring the temperature of the battery cell 2 that is thermally coupled to the thermoelectric module 6. In the exemplary scenario of FIG. 2, one such temperature sensor 14a-14e is provided in each row of elements 8a-8e. In simplified versions, however, such temperature sensors 14a-14e can also be omitted in one or more rows of elements 8a-8e. Conversely however it is also conceivable to arrange more than only one temperature sensor 14a-14e in the individual rows of elements 8a-8e. In this case, a matrix-like arrangement of the temperature sensors 14a-14e can be practical in order to be able to determine the spatially resolved temperature. It is true in principle that increasing number of temperature sensors 14a-14e the spatial resolution of the temperature determination made possible by means of the temperature sensors 14a-14e can also be increased.

The temperature sensors 14a-14e can be designed as conventional temperature sensors such as for example PTC sensors, which are based on an electric resistance measurement. Alternatively to this, they can, however, be also designed as infrared sensors by means of which the infrared radiation emitted by the battery cell 2 can be measured to determine the temperature.

Furthermore, the temperature control device 1 comprises an open-loop/closed-loop control unit 15 interacting both with the temperature sensors 14a-14e and also with the switching elements 11a-11e, which are roughly shown schematically in FIG. 1, but the representation of which was omitted however for the sake of clarity in FIG. 2. The open-loop/closed-loop control unit 15 is equipped/programmed in such a manner that it switches over the electric switching elements 11a-11e between the opened and the closed state in each case as a function of the temperature measured by the temperature sensor 14a-14e of the same row of elements 8a-8e. To this end, the temperature sensors 14a-14e are connected to the open-loop/closed-loop control unit 15 via suitable signal lines—in FIG. 1, only the signal line 30a assigned to the temperature sensor 14a is shown for the sake of clarity—, so that the current temperature value measured by the temperature sensor 14a can be transmitted to the open-loop/closed-loop control unit 15.

For activating the electric switching elements 11a-11e, suitable electrical control lines—FIG. 1 again only shows one such control line 31a for the sake of clarity—lead from the open-loop/closed-loop control unit 15 to the electric switching element 11a-11e. The closed-loop control of the temperature control brought about by the temperature control device 1 can take place for example in such a manner that the open-loop/closed-loop control unit 15 switches one or more switching elements 11a-11e over into the closed state, in which the thermoelectric elements contribute to the temperature control of the battery cell 2, as soon as the temperature measured by the temperature sensors 14a-14e exceeds a predetermined first threshold value and is again switched over into the opened state, in which the thermoelectric elements 9a-9e are switched off and do not contribute to the cooling of the battery cell 2, as soon as the temperature measured by the temperature sensor 14a-14e falls below a second threshold value. The second threshold value in this case can be equal to the first threshold value or for realising a hysteresis curve be smaller than the first threshold value. The open-loop/closed-loop control device 15 can be equipped/programmed in such a manner that an individual closed-loop temperature control is carried out for the temperature sensors 14a-14e of a certain row of elements 8a-8e—in the simplest case, a single temperature sensor 14a-14e for each row of elements 8a-8e and the electric switching element 11a-11e assigned to these temperature sensors 14a-14e. In conjunction with the common open-loop/closed-loop control unit 15 and the electric switching elements 11a-11e, the temperature sensors 14a-14e allow a closed-loop control of the heating or cooling performance provided by the thermoelectric elements 9a-9e arranged in the branch conductors 10a-10e as a function of the temperature of the battery cell 2 coupled to these thermoelectric elements 9a-9e. This leads to an improved, homogenised temperature control of the battery cells 2 of the battery 23 by the thermoelectric elements 9a-9e.

The electric switching elements 11a-11e can comprise a semiconductor switch, in particular a thyristor. By means of such a semiconductor switch the controllability of the electric switching element that is required for realising the closed-loop temperature control explained above can be ensured by the open-loop/closed-loop control unit 15 in a simple manner. The use of a thyristor is recommended since the same is particularly suitable for controlling high electric currents which are required for operating thermoelectric elements 9a-9e.

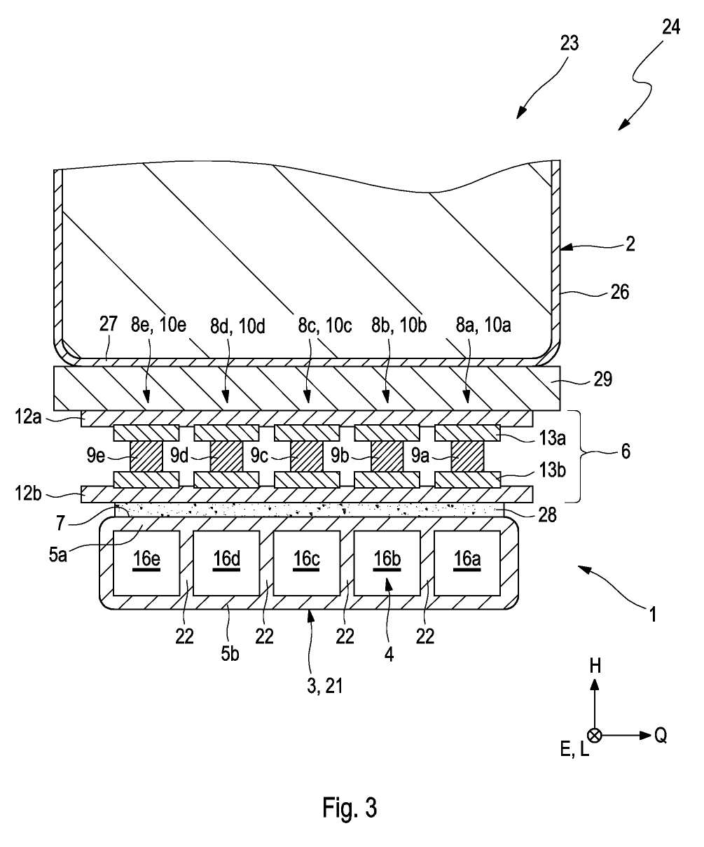

FIG. 3 shows the temperature control device 1 in a cross section along the section line of FIG. 2. As is clearly confirmed by the FIG. 3, it is not only a single fluid duct 16a that is formed in the interior chamber 4 of the temperature control structure 3 but an individual fluid duct 16a-16e is provided for each row of elements 8a-8e. The fluid ducts 16a-16e are arranged in the temperature control structure 3 in such a manner that each fluid duct 16a-16e is thermally coupled to a row of elements 8a-8e to which it is assigned.

Particularly practically, the temperature control structure 3 can be designed as flat pipe 21 as shown in FIG. 3, in which the fluid ducts 16a-16e are formed by means of suitable separating walls 22 and are fluidically separated from one another. The first pipe wall 5a in this case lies flat against the second insulation element 12b with its side 7 facing the thermoelectric module 6. Between the second electrical insulation element 12b realised as circuit board and the first pipe wall 5a, a contact layer 28 of a heat-conductive adhesive can be provided. This results in a large-area thermal contact of the fluid ducts 16a-16e of the flat pipe 21 with the thermoelectric module 6.

As is further evident from FIG. 3, the fluid ducts 16a-16e and the thermoelectric elements 9a-9e of the rows of elements 8a-8e each extend along the already introduced extension direction E, which is identical to the longitudinal direction L in the exemplary scenario. With respect to the likewise already defined vertical direction H, which runs orthogonally both to the extension direction E or longitudinal direction L and also to the transverse direction Q, each fluid duct 16a-16e thus runs spaced from the row of elements 8a-8e assigned to it and parallel to the same.

Now looking again at FIG. 1, in which merely the fluid duct 16a assigned to the first row of elements 8a is shown, it can be seen that in the fluid duct 8a a valve channel 17a is provided. The same can be switched over between a closed position shown in FIG. 1, in which it closes off the fluid duct 17a, and an opened position (not shown), in which it opens the fluid duct 16 for fluid to flow through.

According to FIG. 1, an electric actuator element 18a interacting with the valve element 17a is also provided in that row of elements 8a, which is assigned to the fluid duct 16a comprising the valve element 17a. This in turn is electrically connected to the thermoelectric elements 9a of the row of elements 8a. Particularly preferably, the actuator element 18a-18e is electrically arranged between two thermoelectric elements 9a-9e, i.e. electrically connected in series between two thermoelectric elements 9a-9e. In this way, the required installation space for housing the respective actuator element 18a-18e can be kept small.

The electric actuator element 18a has two operating states and interacts with the valve element 17a in such a manner that it adjusts the valve element 17a into the opened position in a first operating state. Accordingly, the actuator element 18a adjusts the valve element 17a into the closed position in a second operating state. To this end, the actuator element 18 can comprise for example an electric coil element 19a which is only sketched roughly schematically in FIG. 1, which is electrically connected in series with the thermoelectric elements 9a of the row of elements 8a and in its first operating state is flowed through by electric current which also flows through the thermoelectric elements 9a, not however in its second operating state. In a version, an inverse relationship between the two operating states of the actuator element 18a and the two positions of the valve element 17a assigned to the actuator element 18a can also be realised.

Such an interaction of actuator element 18a and valve element 17a makes it possible to couple the thermoelectric elements 9a of the row of elements 8a to the valve element 17a of the fluid duct 16a assigned to this row of elements 8a. Accordingly, the heating or cooling performance generated by the thermoelectric elements 9a can also be coupled to the heating or cooling performance generated by the fluid flowing through the fluid duct 16a.

Switching over the actuator element 18a between its two operating states takes place indirectly by switching over the electric switching element 11a. Accordingly, the fluid duct 16a that can be “additionally switched on” by means of the valve element 17a can be included in the closed-loop temperature control explained above. In the closed state of the electric switching element 11a, an electric flow of current through the thermoelectric elements 9a and thus also through the electric actuator element 18a is possible. The electric actuator unit 18 is then in its first operating state in which it brings about adjusting of the valve element 17a into the opened position.

When the electric switching element 11a is switched over into the opened state, this leads to an interruption of the electric flow of current through the thermoelectric elements 9a of the row of elements 8a and also through the electric actuator element 18a, so that the same is switched into its first operating state. Following this, the valve element 17a is also switched over into the closed state in which flowing of a fluid through the fluid duct 16a is prevented.

The opening of the fluid duct 16a by the valve element 17a which accompanies the first operating state of the actuator element 18a, in the case of the design of the actuator element 18a as electric coil element 19a shown in the example, can take place as follows: by way of the electric flow of current through the coil element 19a, a magnetic field is generated which in turn causes the valve element 17a to be adjusted into the opened position. To this end, the valve element 17 can comprise a spring-elastic element 20a in the form of a leaf spring, which is preloaded against the closed position. If the spring-elastic element 20a has magnetic properties, the spring-elastic element 20a is moved into the opened position with the help of the magnetic field generated by the actuator element 18a.

Switching off the electric current by means of the actuator element 18a by opening the electric switching element 11a also results in the magnetic field generated by the coil element 19a being switched off. The preloaded spring-elastic element then moves back again into the closed position in which it closes off the fluid duct 16a.

Obviously, a preload of the spring-elastic element 20a into the opened position is also conceivable in a version of the example.

In the scenario introduced above, the electric actuator element 18a is designed in such a manner that it interacts free of contact with the valve element 17 by means of magnetic coupling for adjusting between the opened and the closed position.

Alternatively to the design as spring-elastic element 20a it is also conceivable to realise the valve element 17a in the form of a microvalve, which is then electrically coupled to the actuator element 18a.

Preferentially, the valve element 17a-17e is arranged in the region of a respective actuator element 18a-18e in particular along the extension direction E. In this way, the desired coupling between valve element and actuator element can be realised particularly effectively.

The interaction of electric switching element 11a, electric actuator element 18a and valve element 17a explained above is not only limited to the first row of elements 8a and to the fluid duct 16a assigned to this row of elements 8a within the scope of the invention introduced here; it rather proves to be advantageous if at least two—particularly preferably all—rows of elements 8a-8e are provided with corresponding actuator elements 18a-18e, for example in the form of electric coil elements 19a-e and in the corresponding fluid ducts 16a-16e also respective valve elements 17a-17e, for example in the form of spring-elastic elements 20a-20e are provided. In other words: the above explanations to the first row of elements 18a and the associated fluid duct 16a apply, mutatis mutandis, also to the remaining rows of elements 8b-8e and the corresponding fluid ducts 16b-16e.

The temperature control device 1 introduced above is also suitable for the temperature control of a battery 23 having more than a single battery cell 2. The temperature control device 1 and at least two battery cells 2 as part of a battery 23 form a battery arrangement 24.

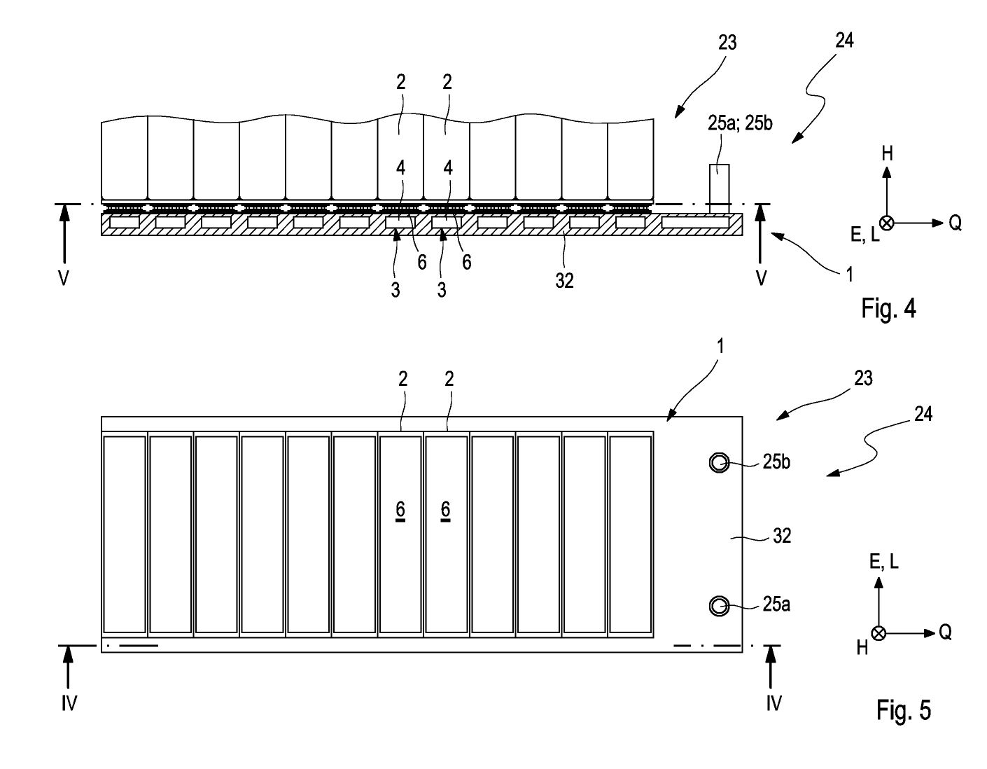

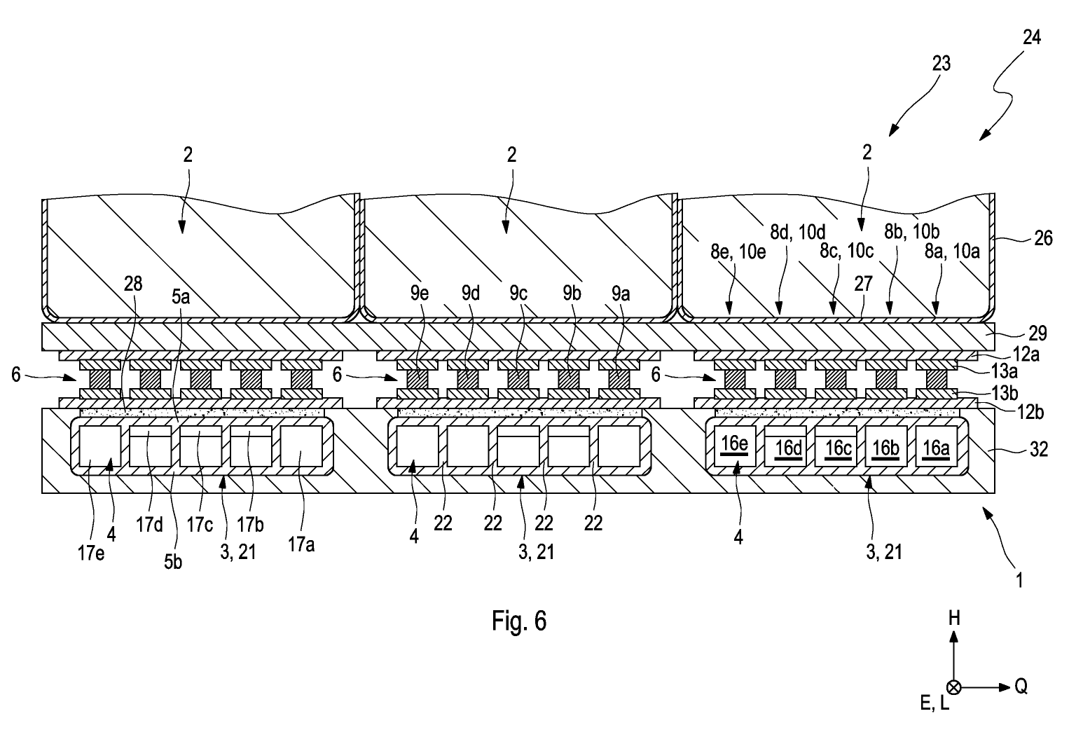

FIG. 4 shows such a battery arrangement 24 with—exemplarily —12 battery cells 2 to be temperature controlled, which together form a battery 23, along a section line IV-IV of FIG. 5. FIG. 5 shows the battery arrangement 24 of FIG. 4 in a cross section along the section line V-V of FIG. 4, the FIG. 6 a detail representation of FIG. 4.

It is evident that the temperature control device 1 for each battery cell 2 comprises a separate thermoelectric module 6. Like the battery cells 2, the thermoelectric modules 6 are arranged next to one another along the transverse direction Q. Each battery cell 2 comprises a housing 26 with a housing wall 27, by means of which the battery cell 2 is mechanically and thermally connected to the thermoelectric module 6 assigned to it.

From FIGS. 4 and 5 it can be seen that the flat pipe 21 for each thermoelectric module 6 has a separate temperature control structure 3 with an interior chamber 4. The interior chambers 4 can be connected to one another via suitable fluid line structures, for example by way of a manifold 32 shown in FIG. 5 in such a manner that the fluid, by way of a common inlet 25a provided on the manifold 32, is distributed over the interior chambers 4 of the temperature control structure 3 and again leaves the same via a common outlet 25b likewise provided on the manifold 32.

Possible technical realisations of fluid control through the manifold 32, the flat pipes 21, the interior chambers 4 formed therein and the fluid ducts 16a-16e again formed in an interior chamber 4 are familiar to the person skilled in the art and will therefore not be discussed in more detail here.

From the detail representation of FIG. 6 it can be seen that the temperature control structures 3 exemplarily shown in this figure and formed as flat pipes 21 can be formed with their interior chambers 4 in each case analogously to the temperature control device 1 as per the FIGS. 1 to 3. Accordingly, FIG. 6 shows that in the respective interior chamber 4 of each of the three flat pipes 21 five fluid ducts 16a-16e are formed, which can be closed off by a respective valve element 17a-17e. In FIG. 6, some valve elements 17a-17e are exemplarily shown in the closed position and some in the opened position.

As already mentioned, the modular concept introduced above allows the temperature control of a battery 23 with any number of battery cells 2. In a preferred version of the battery arrangement 24 introduced here, the battery 23 thus comprises a plurality of battery cells 2.

In a particularly preferred version of the battery arrangement 24, at least one temperature sensor 14a-14e can be arranged in each case for each pair of a battery cell 2 and thermoelectric module 6. This allows a particularly accurate temperature measurement of the temperature of the individual battery cells 2 and thus also an individual temperature control of the battery cells 2. To this end, the closed-loop temperature control performed by the open-loop/closed-loop control unit 15 can switch over the switching elements 11a-11e of a respective thermoelectric module 6 as a function of the temperature between its closed and opened state, which can be determined by the at least one temperature sensors 14a-14e assigned to this thermoelectric module 6. The switching over of the electric switching element 11a-11e then accompanies a switching on and switching off of the row of elements 8a-8e comprising the respective switching element 11a-11e and of the valve elements 17a-17e assigned to the rows of elements 8a-8e via respective actuator elements 18a-18e.

1. A temperature control device for a temperature control of at least one battery cell of a battery, comprising:
a temperature control structure through which a fluid is flowable, the temperature control structure having at least one first pipe wall defining an interior;
at least one thermoelectric module, which on a side facing away from the interior chamber of the temperature control structure is arranged on the at least one first pipe wall;
wherein the thermoelectric module includes at least two rows of elements each with at least two thermoelectric elements;
wherein the at least two rows of elements each extends along an extension direction;
wherein the at least two thermoelectric elements of a first of the at least two rows of elements are electrically connected in series for forming a first electric branch conductor, and the at least two thermoelectric elements of at least a second of the at least two rows of elements are electrically connected in series for forming a second electric branch conductor; and
wherein in at least one row of elements, an electric switch is provided, the electric switch being switchable between a closed state and an opened state.

2. The temperature control device according to claim 1, wherein:
the at least two thermoelectric elements of a row of elements are substantially arranged linearly along a longitudinal direction;
the at least two rows of elements are arranged adjacent to one another along a transverse direction running transversely to the longitudinal direction;
the at least two thermoelectric elements of a row of elements are arranged along a vertical direction, which runs orthogonally to the longitudinal direction and to the transverse direction, between a first electrically insulating insulation element and a second electrically insulating insulation element; and
the second electrical insulation element is arranged in the vertical direction between the thermoelectric elements and the at least one first pipe wall of the temperature control structure.

3. The temperature control device according to claim 1, wherein the at least one thermoelectric module includes at least one temperature sensor for measuring a temperature of a battery cell that is thermally coupled to the at least one thermoelectric module.

4. The temperature control device according to claim 3, further comprising an open-loop/closed-loop control unit interacting with the at least one electric switch and the at least one temperature sensor, the control unit being configured to switch the at least one electric switch between the opened state and the closed state as a function of the temperature measured by the at least one temperature sensor.

5. The temperature control device according to claim 3, wherein:
the at least one temperature sensor is provided in at least one of the at least two rows of elements; and
an open-loop/closed-loop control unit configured to switch the at least one electric switch between the opened state and the closed state as a function of the temperature measured by the at least one temperature sensor is designed in such a manner that the at least one switch a in the at least one of the at least two rows of elements is activated by the open-loop/closed-loop control unit as a function of the temperature measured by the at least one temperature sensor provided in the at least one of the at least two rows of elements.

6. The temperature control device according to claim 1, wherein at least one switch includes a semiconductor switch.

7. The temperature control device according to claim 3, wherein the at least one temperature sensor is an infrared sensor configured to measure the temperature of the at least one battery cell by determining a temperature an infrared radiation emitted by the at least one battery cell.

8. The temperature control device according to claim 1, wherein the at least one electric switch is provided on a side of the at least one thermoelectric module facing the temperature control structure.

9. The temperature control device according to claim 1, wherein:
in the temperature control structure, a fluid duct is provided for each row of elements and is arranged in such a manner that each fluid duct is thermally coupled to the corresponding row of elements; and
in at least one fluid duct, a valve is provided, the valve being adjustable between a closed position, in which the valve closes the fluid duct, and an open position, in which the valve opens the fluid duct for the fluid to flow through.

10. The temperature control device according to claim 9, wherein:
in the row of elements corresponding to the at least one fluid duct with a valve, an electric actuator is provided, the electric actuator being electrically connected to the at least two thermoelectric elements of the corresponding row of elements; and
the actuator interacts with the valve of the corresponding fluid duct in such a manner that the actuator adjusts the valve into the opened position in a first operating state and adjusts the valve into the closed position in a second operating state.

11. The temperature control device according to claim 10, wherein:
the electric actuator includes an electric coil electrically connected in series with the at least two thermoelectric elements, wherein in the first operating state, the electric coil is flowed through by an electric current, but not in the second operating state.

12. The temperature control device according to claim 9, wherein the valve includes a spring-elastic element preloaded against one of the opened position or the closed position.

13. The temperature control device according to claim 9, wherein the valve is designed as a microvalve.

14. The temperature control device according to claim 10, wherein the actuator is electrically arranged between two thermoelectric elements.

15. The temperature control device according to claim 10, wherein the valve is arranged in a region of the actuator along the extension direction.

16. The temperature control device according to claim 1, wherein the electric switch is electrically arranged between two thermoelectric elements.

17. A battery arrangement, comprising:
a temperature control device having:
a temperature control structure through which a fluid is flowable, the temperature control structure having at least one first pipe wall defining an interior;
at least one thermoelectric module, which on a side facing away from the interior chamber of the temperature control structure is arranged on the at least one first pipe wall;
wherein the thermoelectric module includes at least two rows of elements each with at least two thermoelectric elements;
wherein the at least two rows of elements each extends along an extension direction;
wherein the at least two thermoelectric elements of a first of the at least two rows of elements are electrically connected in series for forming a first electric branch conductor, and the at least two thermoelectric elements of at least a second of the at least two rows of elements are electrically connected in series for forming a second electric branch conductor; and
wherein in at least one row of elements, an electric switch is provided, the electric switch being switchable between a closed state and an opened state; and
at least one battery including a battery cell, wherein the at least one battery cell is arranged on a side of the at least one thermoelectric module of the temperature control device facing away from the temperature control structure.

18. The battery arrangement according to claim 17, wherein:
the at least one thermoelectric module includes at least two thermoelectric modules;
the at least one battery cell includes at least two battery cells; and
each battery cell includes a housing with a housing wall by which the battery cell is mechanically and thermally connected to the corresponding thermoelectric module.

19. The battery arrangement according to claim 17, wherein the at least one battery cell includes a plurality of battery cells and for each battery cell, exactly one thermoelectric module that is mechanically and thermally connected to the corresponding battery cell.

20. The battery arrangement according to claim 19, wherein for each pair of a battery cell and a thermoelectric module, at least one temperature sensor is provided.

21. The battery arrangement according to claim 17, further comprising an open-loop/closed-loop control unit configured to switch over the electric switch of each thermoelectric module between the closed state and opened state as a function of a temperature of a battery cell corresponding to the thermoelectric module as measured by at least one temperature sensor of the thermoelectric module.
